(19) United States
(12) Patent Application Publication
(10) Pub. No.: US 2010/0065656 A1
(43) Pub. Date: Mar. 18, 2010

(54) Water Deflection Subassembly

(76) Inventor: Stuart F. Grant, Long Beach, FL (US)

Correspondence Address: NIXON & VANDERHYE, PC, 901 NORTH GLEBE ROAD, 11TH FLOOR, ARLINGTON, VA, 22203, US

(21) Appl. No.: 12/225,177

(22) PCT Filed: Mar. 21, 2007
(86) PCT No.: PCT/US07/06978

§ 371 Date: Sep. 8, 2009

Related U.S. Application Data
(60) Provisional application No. 60/784,295, filed on Mar. 21, 2006.

(51) Int. Cl. B05B 3/04; B05B 3/10

(52) U.S. Cl. 239/222.11; 239/223; 239/231; 239/265

(57) ABSTRACT

A sprinkler device comprising a rod having a distribution plate secured thereto, the rod located relative to a nozzle adopted to emit a liquid onto the water distribution plate to thereby create a force on the rod in one direction; a support component including at least two retaining rings through which the rod passes; and a pair of magnets, one of which is fixed to the rod and the other of which is located in proximity to the one magnet, wherein poles of the magnets are arranged to create a repulsion force tending to move the rod in a second direction opposite the first direction.

Priority is claimed from Provisional Application No. 60/784,295 filed Mar. 21, 2006.

### BACKGROUND

1. Field of the Invention

This invention relates generally to a device for deflecting and distributing liquids and, in particular, to a mechanism suitable for spreading relatively small amounts of water.

2. Description of the Related Art

Sprinklers of various types and sizes are used in a number of environments. In one common implementation, a sprinkler system is used to water a lawn. The challenge in watering a lawn is, of course, to achieve a relatively even dispersion of water from a point source. Different sprinklers surmount this obstacle using different methods. A very simple example of a sprinkler system is the watering can. A relatively large amount of water is poured through a large area spout having a number of holes therethrough. The water travels through the holes along a number of trajectories and is thereby dispersed.

A number of other sprinkler systems operate via turbine or jet power. The flow from a relatively high volume of water is thereby converted into linear or rotational force. This force is then used to operate some sort of mechanical disperser, which evenly distributes the water. These systems operate fairly well for many applications, especially when watering a significant amount of land, where a large flow of water is necessary and desirable.

Unfortunately, these prior art water dispersion and sprinkler systems require relatively high water pressure and volume to operate correctly. Therefore, these devices are ill-suited for low-flow applications, such as, for example, precision watering of a single plant, watering on steep inclines prone to water runoff, or watering of highly packed soil that is resistant to absorption.

### SUMMARY OF THE INVENTION

According to one embodiment of the present invention, a system for deflecting and distributing liquid from a liquid source is provided. The system comprises a conical element disposed along a rod, and a retaining structure, for example a ring or guide, adapted to enclose at least a portion of the rod. The conical element further comprises a series of diagonal, spaced grooves or other structure configured to receive and deflect the liquid. The conical element and the rod are configured to spin relatively freely within the retaining ring.

In one embodiment, the rod is coupled to a magnet, and the system includes an opposing magnet adapted to direct a force to the rod in a direction generally equal and opposite that of the force from the water flow.

### BRIEF DESCRIPTION OF THE DRAWINGS

The preferred embodiments of this invention, illustrating all its features, will now be discussed in detail. These embodiments depict the novel and nonobvious method and system of this invention shown in the accompanying drawings, which are for illustrative purposes only. The drawings include the following Figures, with like numerals indicating like parts.

FIG. 1 shows a perspective view of a water deflection subassembly according to one embodiment of the present invention;

FIG. 2 shows a perspective view of a water deflection subassembly according to a second embodiment of the present invention;

FIG. 3 shows a perspective view of a water deflection subassembly according to a third embodiment of the present invention;

FIG. 4 shows a perspective view of a water deflection subassembly according to a fourth embodiment of the present invention;

FIG. 5 shows a perspective view of a water deflection subassembly according to a fifth embodiment of the present invention, with upper and lower bearing blocks split for the sake of clarity;

FIG. 6 shows a perspective view of a water deflection subassembly according to a sixth embodiment of the present invention, with an upper bearing block split for clarity;

FIG. 7 shows a perspective view of a water deflection subassembly according to a seventh embodiment of the present invention;

FIG. 8 shows a perspective view of a water deflection subassembly according to an eighth embodiment of the present invention;

FIG. 9 shows a perspective view of a water deflection subassembly according to a ninth embodiment of the present invention; and

FIG. 10 shows a perspective view of a water deflection subassembly according to a tenth embodiment of the present invention.

### DETAILED DESCRIPTION OF THE DRAWINGS

In one embodiment of the present invention, a water deflection subassembly is disclosed that can be used to disperse water or other liquids. In order to do so, one embodiment of the present invention includes a substantially conical element having grooves disposed on its external surface. As water contacts this surface, the conical element is caused to spin on its longitudinal axis. The conical element may be supported in a relatively frictionless environment by use of magnets in one embodiment, and the conical element can therefore spin relatively freely. As the conical element spins, water contacting its external surface is deflected from the conical element at different angles, and the water is thereby dispersed.

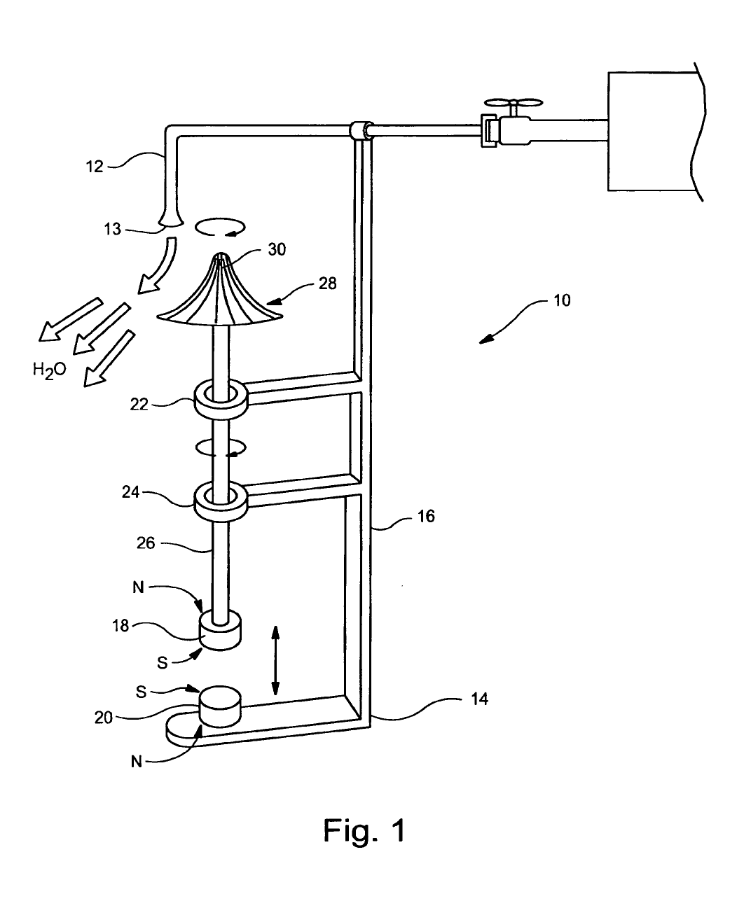

FIG. 1 illustrates one embodiment of a water deflection subassembly 10. As illustrated, a water jet conduit 12 is located above the water deflection subassembly 10, with a nozzle 13 representing the point source of water that is dispersed toward the water deflection assembly. This water jet conduit 12 is preferably fixed to subassembly 10 such that the emitted water jet is off center and parallel to the central axis of the subassembly 10, but in other configurations it can be positioned along the central axis of the subassembly 10 and fixed thereto. Of course, in other embodiments, the deflected liquid need not be water, but may be any of a number of liquids. In other embodiments, the liquid may comprise, for example, biological broths or liquid chemicals undergoing heat-generating reactions that may be advantageously cooled or oxidized as they form droplets dispersed through the air. As shown in FIG. 1, the liquid flowing from the water jet is propelled by gravity. However, in other embodiments, a variety of pumps or other means for moving water against gravity may be used to propel the water towards the water deflection subassembly 10.

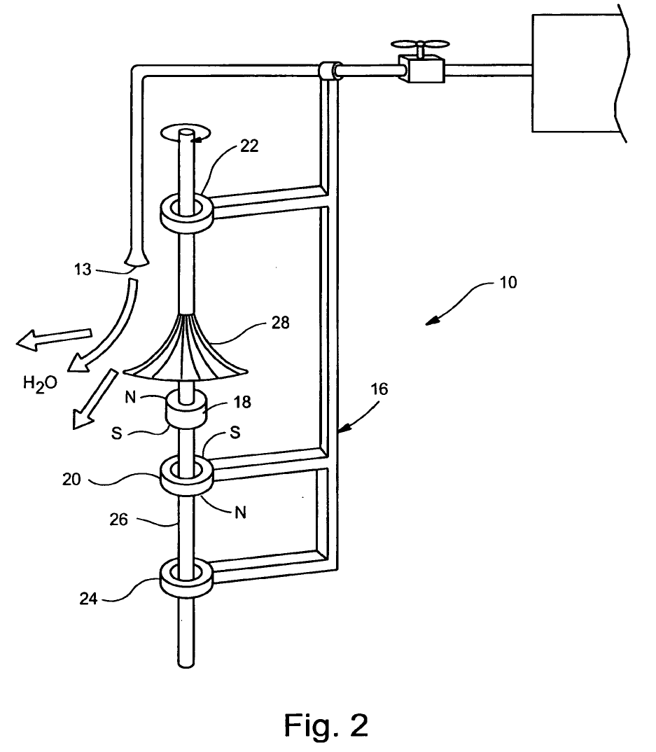

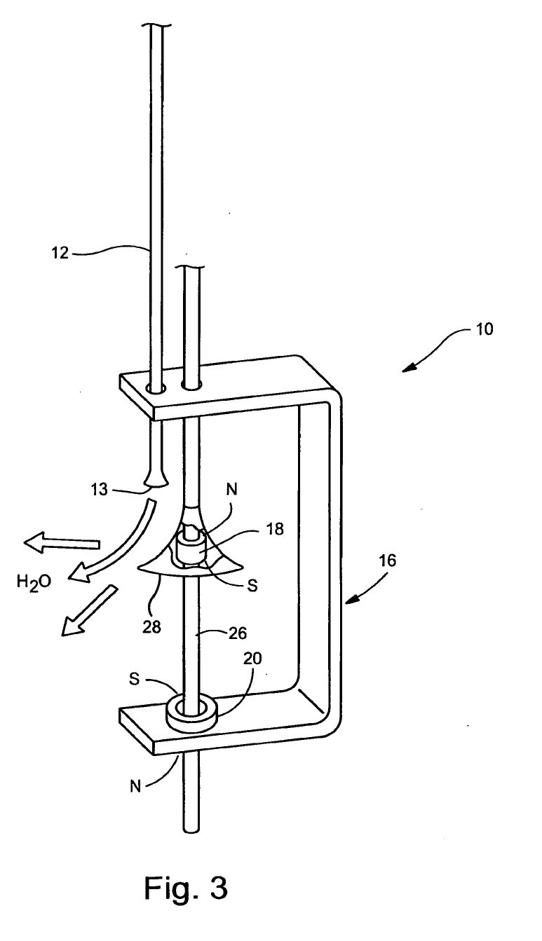

As shown in FIG. 1, the water deflection subassembly 10 may comprise a base 14 and a pole support or frame 16, two opposing magnets 18, 20, retaining rings 22, 24, a rod 26 and a conical element 28. The base 14 and pole support 16 are used to maintain the relative positions of the other elements of the water deflection subassembly 10 and may be manufactured in a variety of ways well known to those of skill in the art. In one embodiment (see, e.g., FIG. 2), the base may simply be the earth from which a plant is growing, and a supporting pole 16 may extend from the earth to maintain the relative positions of other elements of the water deflection subassembly, including, for example, the opposing magnet 20. In another embodiment (best seen in FIG. 3), the pole support may not be a separate element but may be formed integrally with the retaining rings. The base 14 and pole or frame 16 may be constructed from any of a number of rigid or semi-rigid materials and may or may not be made from the same material. In a preferred embodiment, the pole 16 and base 14 may be constructed from a rigid, inexpensive plastic material.

The pole 16 supports the retaining rings 22, 24, one located above the other. These rings 22, 24 may be constructed of the same or different materials and are preferably constructed from a rigid or semi-rigid material having a relatively low coefficient of friction. The upper ring 22 may have a larger or smaller radius than the lower ring 24. The rings 22, 24 may also be centered about the same or a different axis. As illustrated, the rings 22, 24 have identical radii and are concentric about the same longitudinal axis. Of course, more or fewer rings may be used in other embodiments. For example, in one embodiment, a single thicker ring may support the rod and conical element. In another embodiment, a third ring may be used to provide further security for the rod and conical element.

In the illustrated embodiment, the conical element 28 is attached to an upper end of the rod 26, and the rod 26 is retained within the retaining rings 22, 24. The rod 26 may be constructed from any of a number of rigid materials and has a length greater than the distance between the retaining rings. The rod 26 may also have a narrower width than the width of the narrowest retaining ring, such that the rod 26 may move relatively freely within the retaining rings.

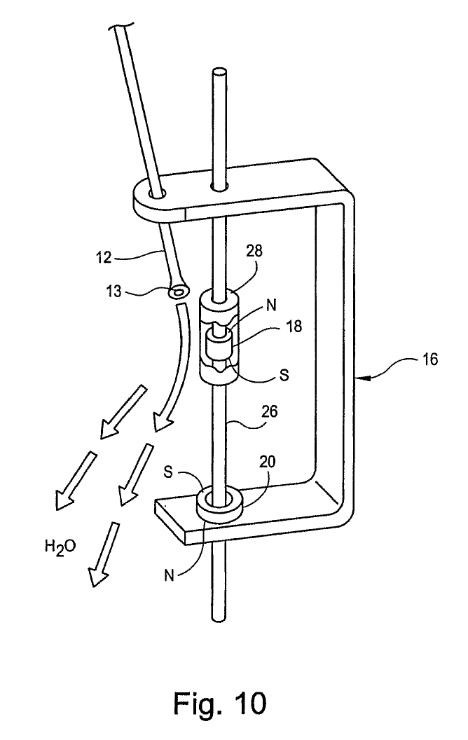

As illustrated, the conical element 28 which serves as a water distribution plate, may have any of a variety of shapes. In fact, the conical element 28 may have any of a number of shapes along which grooves or ridges can be disposed, even a spherical shape. In one embodiment, (best illustrated in FIG. 10) the conical element 28 need not be tapered, as the whole rod leans and spins at an angle relative to the axis of the impinging water. The conical element 28 is preferably rigid and may be constructed from the same or different materials as the rod 26 to which it is attached. As may be seen in FIG. 1, the conical element 28 has diagonal grooves 30 disposed thereon. These grooves 30 may have a variety of shapes and configurations. In one embodiment, these grooves 30 curve along the surface of the conical element 28 and may be fairly shallow. However, in other embodiments, at least a subset of the grooves may be more or less diagonal and may have varying depths and spacing between them. The element 28 need not be conical but can have any suitable shape for dispersing liquid.

In one embodiment, at a lower end of the rod 26, distal from the conical element 28, the rod 26 is attached to a magnet 18. As illustrated, this magnet 18 has its South Pole facing downwards, and its North Pole facing upwards. Of course, these polarities may be otherwise disposed in other embodiments. The magnet 18 may comprise any of a number of magnetic materials well known to those of skill in the art. In a preferred embodiment, the magnet 18 comprises a ferromagnetic material. The magnet 18 attached to the rod 26 may also be attached at various locations, more or less proximal to the conical element 28, as will be apparent from the remaining Figures.

Located on the base 14 below the magnet 18 attached to the rod, another magnet 20 may be oriented to oppose the magnet 18 attached to the rod (i.e., like poles facing each other). Thus, the rod 26 is forced away from the base 14 and hangs suspended within the retaining rings 22, 24. The magnets allow the rod and conical element to remain suspended above the base with relatively little friction impeding their spinning.

The embodiment of FIG. 1 will now be described in operation. In an inactive state, the rod 26 is suspended above the base 14 by the force between the two magnets 18, 20.

When water is allowed to fall from the water jet conduit 12, it contacts the external surface of the conical element 28 as shown. The water then flows along the diagonal grooves 30, and the weight of the water (and the force with which the water contacts the grooves) spins the conical element. Since the grooves 30 are oriented diagonally along the conical element 28, the force from the water may also impart a tangential component to the conical element 28, thus spinning the rod 26 and conical element 28. In the illustrated embodiment, the conical element 28 spins in a clockwise direction viewed from the top.

As soon as the water starts to contact the conical element 28, the conical element 28 also experiences an additional downward force, and thus the rod 26 and conical element 28 and rod-attached magnet 18 are reoriented to a lower position relative to its inactive state.

As conical element 28 and rod 26 spin on its longitudinal axis within the rings 22, 24, the water flowing from the water jet conduit 12 is deflected off of the conical element and is thereby distributed at various angles to one side of the subassembly 10. Since the function of thrust bearing is accomplished by the repelling force between base magnet 20 and rod-attached magnet 18, a relatively small amount of friction is experienced and therefore very little water flow is required to drive this simple turbine.

In FIG. 2, another embodiment of the present invention is shown. In this embodiment magnet 20 is a ring magnet, also mounted on the supporting pole 16, and situated along the vertical axis above the lower retaining ring 24 rather than below it, thus allowing rod 26 to pass through the ring of magnet 20 without contacting it. Both the liquid dispersing element 28 and rod-attached magnet 18 are placed at intermediate locations along the rod 26, and between the upper retaining ring 22 and the ring magnet 20, rather than at either end of rod 26 as in the previous embodiment. This embodiment of the water deflection subassembly 10 should function in substantially the same way as that described above, with reference to FIG. 1.

In FIG. 3, yet another embodiment of the present invention is shown. FIG. 3 shows an embodiment substantially similar to that of FIG. 2. However dispersing element 28 and rod-attached magnet 18 are fused together at a position intermediate along the length of rod 26, and the rod passes through a pair of support flanges of the pole support or frame 16. In this embodiment ring magnet 20 also serves as the lower retaining ring and contains the lower portion of rod 26. Support 16 may be welded or otherwise suitable secured to the water jet conduit 12.

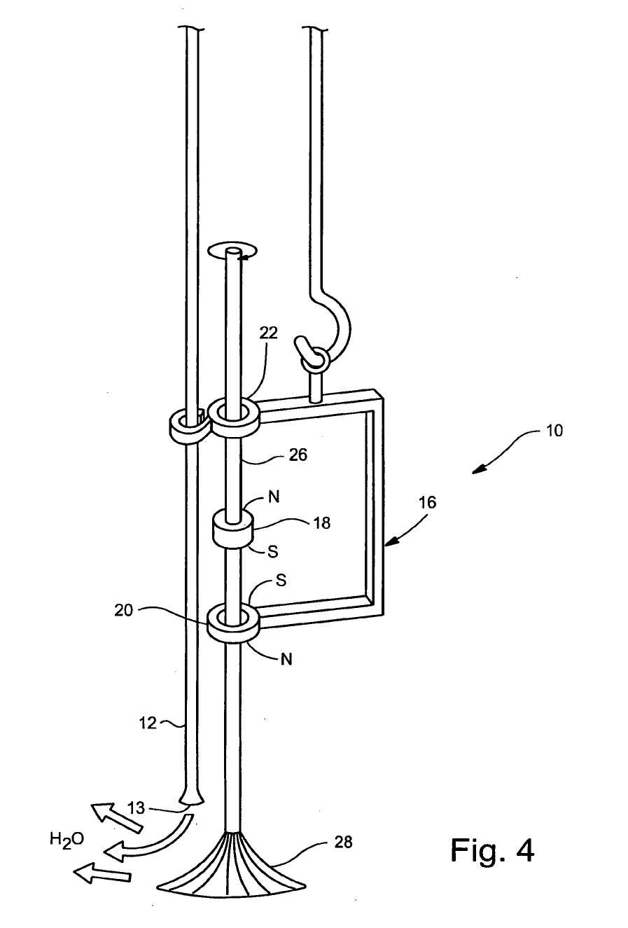

In FIG. 4, yet another embodiment of the present invention is shown. This embodiment may be constructed very similarly to that of FIG. 2 or FIG. 3. In this configuration, as in FIG. 3, ring magnet 20 fixed to the frame 16 along the vertical axis also serves as the lower retaining ring containing the lower portion of rod 26. Rod magnet 18 is disposed intermediate along the length of the rod and dispersing element 28 is now positioned along the rod below the lower retaining ring (ring magnet 20) in order to allow the water to fall more freely without interacting with other elements of assembly 10. This embodiment also demonstrates that the particular placement of the dispersing element 28 along rod 26 is not essential for the working of the assembly 10.

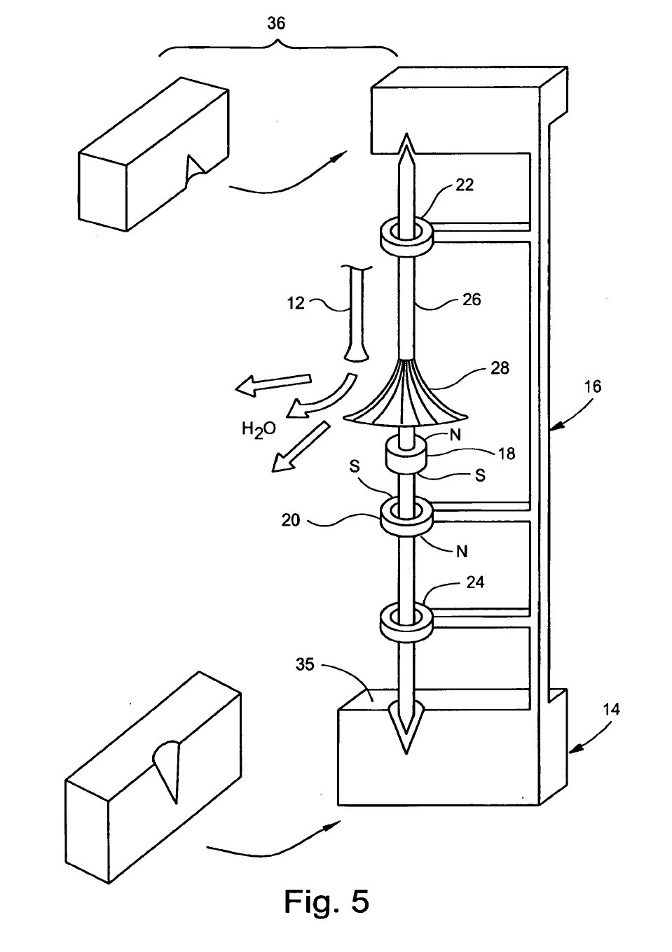

In FIG. 5, another embodiment of the present invention is shown. FIG. 5 shows an embodiment similar to FIG. 2, but in this embodiment, upper and lower conventional thrust bearings 35, 36 are added to the support 16, at the upper end and at the lower base 14, respectively, to expand the range of operating pressures at which the device will operate and to allow a more compact design by limiting the vertical travel of the rotor. In this embodiment the repelling magnet pair 18, 20 acts only to suspend the rotor at or slightly above the bearing surface of bearing 35 to minimize or eliminate contact pressure between rod 26 and the bearing 35 in the inactive state. This allows the system to start with minimum friction, thus allowing the system to function at a lower pressure and/or lower water volume such as is experienced during startup conditions.

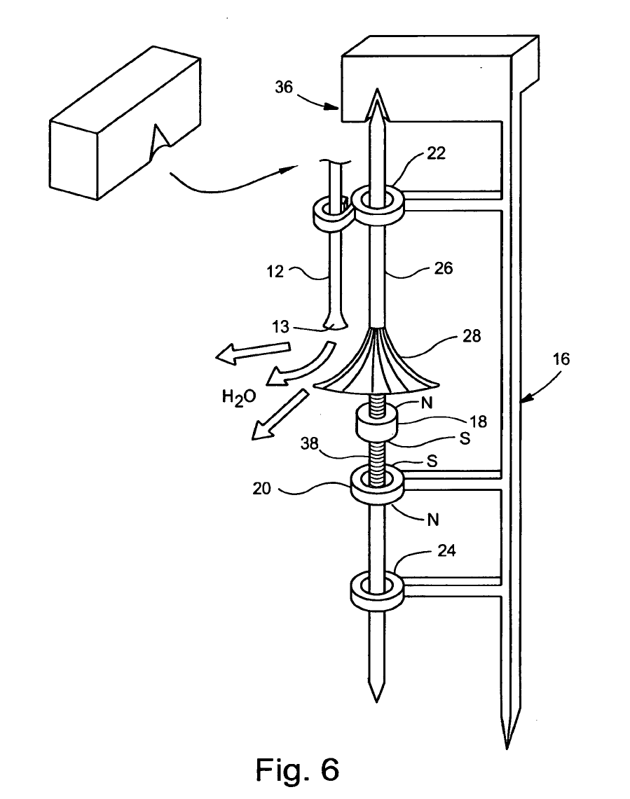

In FIG. 6, another embodiment of the present invention is shown. FIG. 6 shows an embodiment similar to FIG. 5, but only an upper bearing 36 is added to effect a preload onto the rod 26 and limit the vertical travel of rod 26 to allow a more compact design. At very low liquid pressures, such as when liquid begins to flow from water jet conduit 12 at startup, the rotor will not spin and the device will not function, as the rotor is too strongly seated in the upper bearing 36, and the friction remains too high. As liquid pressure from the nozzle is further increased, the contact pressure between rod and upper bearing socket diminishes as a function of the force of the water jet, until torque overcomes friction and the device is allowed to spin. As water pressure is increased still further, opposing magnetic force is further overcome and rod 26 of the rotor will reposition itself to a lower position vertically and lose contact entirely with the upper bearing surface. Rod 26 will then be allowed to spin even more freely in a relatively frictionless environment. Adjustment threads are provided along rod 26 to allow the magnet 18 to be adjusted up or down vertically on rod 26 to alter the pre-force on the magnet pair and thus allow the device to be optimized for a particular range of operational water pressure. While this device will not operate at the lower pressures of some of the earlier mentioned embodiments, at higher pressure ranges predetermined by the strength and positioning of the opposing magnet pair this system will have the advantages of a low friction mechanical watering device. These advantages include: large water droplets, a minimum of unwanted mist or spray, and a longer throw that is consistent with a reduction in mechanical friction losses.

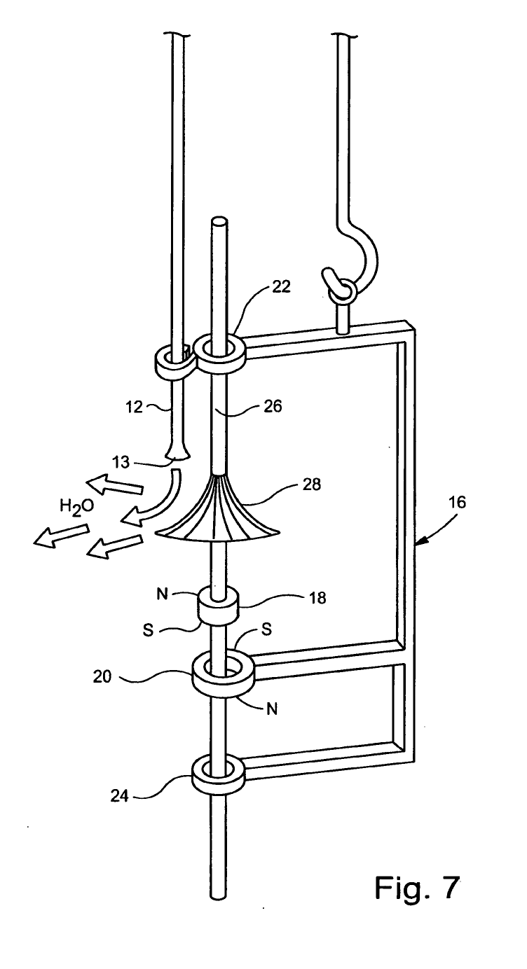

In FIG. 7, yet another embodiment of the present invention is shown. FIG. 7 shows an embodiment substantially similar to that of FIG. 2, but with the ring magnet 20 slightly displaced radially (or laterally) in order to compensate for the sideways thrust generated by the deflected water stream. In this embodiment as pressure is increased and the rod 26 repositions down to a lower position on subassembly 10, a lateral shifting force is also generated between the two opposing magnets 18 and 20. This lateral force is opposite the force generated by the deflecting water stream and therefore radial contact force of rod 26 against rings 22 and 24 is diminished and the rotor is allowed to spin more freely. In this embodiment an opposing lateral force is generated by displacing ring magnet 20 radially, but in other embodiments different placements of magnets, shapes of magnets and/or different quantities of magnets may be used by those of skill in the art to generate a desired radial thrust.

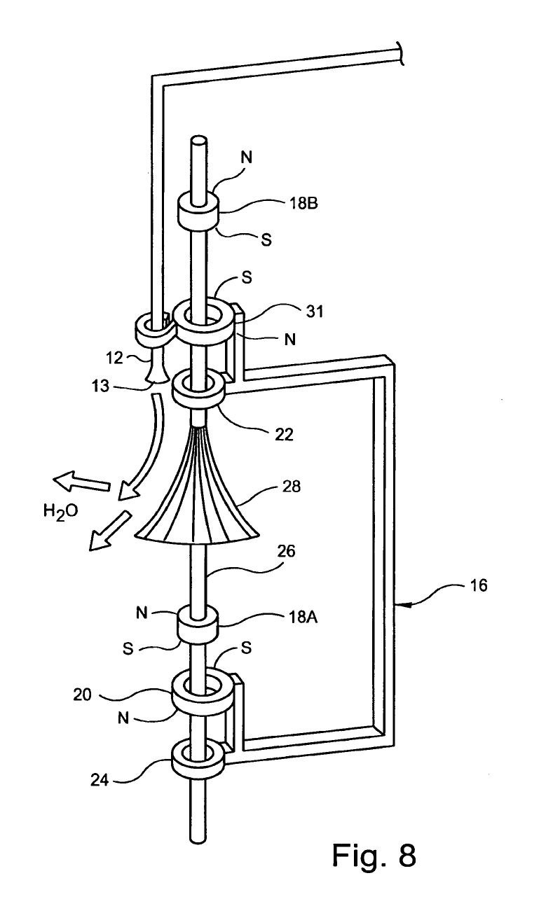

In FIG. 8, yet another embodiment of the present invention is shown. FIG. 8 shows an embodiment substantially similar to that of FIG. 7, however a second pair of opposing magnets 18B and 31 is incorporated into the upper portion of device, along with the first pair of magnets 18A and 20. In this embodiment both ring magnets 20, 31 attached to the frame 16 are slightly displaced radially such that if a downward force is applied to rod 26 a sideways thrust is generated at both ends of rod 26 to counter the opposing sideways thrust from the deflecting water jet, and thus minimize contact force and friction of rod 26 against rings 22 and 24.

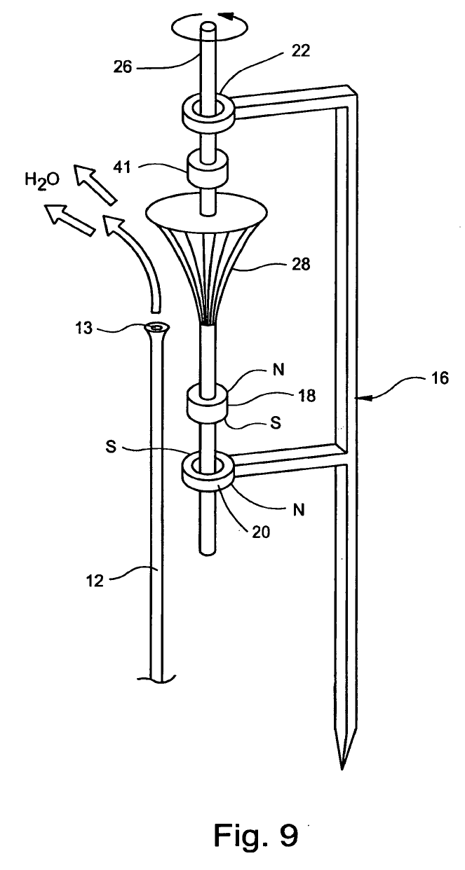

In FIG. 9, another embodiment of the present invention is shown. In this embodiment, the conical element 28 is oriented towards the ground, and the water is shot up from water jet conduit 12 and nozzle 13 into contact with the conical element 28 causing it to spin. In one embodiment the upwards force of the water stream against the conical element 28 may oppose the force of gravity on the rotor during use. As the upwards force of the liquid impinging upon deflecting cone 28 is increased, the magnets 18 and 20 are caused to move further apart so that the water stream from jet 26 is caused to support a greater portion of the weight of the rotor. Weight 41 fixed to rod 26 above deflecting cone 28 functions to counter a greater force from the water jet to allow device to operate with a greater water volume impinging against deflecting cone 28.

Magnets 18, 20 are illustrated in FIG. 9, but they need not be used to make this particular embodiment work. In fact, in many of the embodiments discussed herein, magnets need not be used, allowing instead the force of gravity to counteract the force of the impinging water jet. In still other embodiments, the rod 26 may be constructed with multiple conical elements, and water may strike these conical elements from multiple directions, thereby suspending the rod 26 without the use of magnets. In a preferred embodiment, the conical elements may be mounted on either end of the rod in a symmetrical configuration, and the water jets may be directly opposing.

In FIG. 10, the deflector plate 28 is substantially cylindrical in shape, with angled grooves receiving the liquid emitted from conduit 12 and nozzle 13. Here, the conduit is angled relative to the longitudinal axis of the rod 26 (and deflector 28).

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. It also is contemplated that various aspects and features of the invention described can be practiced separately, combined together, or substituted for one another, and that a variety of combinations and sub combinations of the features and aspects can be made that still fall within the scope of the invention. Moreover, the different elements of these subassemblies 10 may be constructed from a number of different suitable materials well known to those of skill in the art, including rustproof metallic surfaces, polymeric surfaces, ceramics, and other materials. Thus, it is intended that the scope of the present invention herein disclosed should not be limited by the particular disclosed embodiments described above.

What is claimed is:

1. A sprinkler device comprising a rod having a liquid distribution plate secured thereto, said rod located relative to a nozzle adopted to emit a liquid onto said water distribution plate to thereby create a force on said rod in a first direction;
a support component including at least two retaining rings through which said rod passes; and a pair of magnets, one of which is fixed to said rod and the other of which is located in proximity to said one magnet, wherein poles of said magnets are arranged to create a repulsion force tending to move said rod in a second direction substantially opposite said first direction.

2. The sprinkler of claim 1 wherein said distribution plate is secured to one end of said rod and the other of said magnets is fixed to an opposite end of said rod.

3. The sprinkler of claim 1 wherein said nozzle is offset from a longitudinal axis of said rod.

4. The sprinkler of claim 1 wherein said water distribution plate is provided with one or more grooves arranged to cause said plate to rotate when struck by the liquid emitted from said nozzle.

5. The sprinkler of claim 1 wherein said support component comprises a substantially vertically oriented pole with a substantially horizontally oriented base, said other of said magnets fixed to said base.

6. The sprinkler of claim 2 wherein said support component comprises a substantially vertically oriented pole with a substantially horizontally oriented base, said other of said magnets fixed to said base.

7. The sprinkler of claim 2 wherein said retaining rings are located intermediate said opposite ends of said rod.

8. The sprinkler of claim 1 wherein distribution plate is located axially between said retaining rings.

9. The sprinkler of claim 8 wherein said at least two retaining rings comprises three retaining rings, said distribution plate located axially between an upper and an intermediate ring of said three retaining rings.

10. The sprinkler of claim 9 wherein said one magnet is located on said rod adjacent and below said distribution plate and the other of said magnets is integrated with said intermediate ring.

11. The sprinkler of claim 1 wherein at least one of two ends of said rod is supported by a thrust bearing.

12. The sprinkler of claim 1 wherein opposite ends of said rod are supported in respective thrust bearings.

13. The sprinkler of claim 12 wherein distribution plate is located axially between said retaining rings.

14. The sprinkler of claim 13 wherein said at least two retaining rings comprises three retaining rings, said distribution plate located axially between an upper and an intermediate ring of said three retaining rings.

15. The sprinkler of claim 14 wherein said one magnet is located on said rod adjacent and below said distribution plate and the other of said magnets is integrated with said intermediate ring.

16. The sprinkler of claim 1 wherein said deflection plate is cylindrical and said nozzle is arranged at an acute angle to said rod, thereby causing liquid to strike a dispersion surface of said deflection plate at said acute angle.

17. A sprinkler device comprising a rod having a liquid distribution plate secured to said rod, wherein said rod slidably passes through a pair of spaced support flanges; a first magnet secured to said rod between said support flanges and a second magnet arranged on one of said support flanges with like poles of said magnets facing each other; and
a nozzle connected to a source of liquid arranged to emit water onto said liquid distribution plate.

18. The sprinkler of claim 17 wherein said liquid distribution plate is conically-shaped, and wherein said first magnet is located within the cross-sectional shape of said liquid distribution plate.

19. The sprinkler of claim 17 wherein said liquid distribution plate is secured to one end of said rod closest to said second magnet.

20. The sprinkler of claim 17 wherein said first magnet is adjustable along a length of said rod.
